(19) United States
(12) Patent Application Publication
(10) Pub. No.: US 2007/0189277 A1
(43) Pub. Date: Aug. 16, 2007

(54) Virtual audio drivers and a virtual audio telephone interface

(75) Inventors: Cheng-Jen Yang, Hsinchu (TW); Mark Zhang, Xi'an (CN)

Correspondence Address: BIRCH STEWART KOLASCH & BIRCH, PO BOX 747, FALLS CHURCH, VA, 22040-0747, US

(73) Assignee: BROWAN COMMUNICATIONS, Inc.

(21) Appl. No.: 11/342,586

(22) Filed: Jan. 31, 2006

(51) Int. Cl. H04L 12/66

(52) U.S. Cl. 370/356

(57) ABSTRACT

The present invention provides a system with virtual audio driver for the VoIP (voice over internet protocol) environment. The virtual audio driver is computer software, and it can be implemented by diverse possibilities. Including being implemented by different programming languages; supporting various operating systems (OS) and so on. It should be appreciated that the virtual audio driver is used for transferring the voice data, instead of producing the sounds. Besides, the present invention also provides a virtual telephone interface. After combining the virtual audio drivers and the virtual telephone interface with the VoIP client applications, users can simply answer VoIP calls from several VoIP client applications by single software.

### FIELD OF THE INVENTION

The present invention relates to a virtual audio driver, and more particularly relates a virtual audio driver for VoIP (voice over internet protocol.)

### BACKGROUND OF THE INVENTION

The VoIP (voice over internet protocol) technologies grow rapidly, and the population of worldwide users using VoIP services also increases largely. Every company tries to provide users the best VoIP services, at the mean time also wants to get the best position in the global market. Users did not have lots of options in VoIP services years ago, and it means that users only need to deal with the specific software at that time. Usually, the users were satisfied with the experience of VoIP services. However, there are various choices of the VoIP services recently. Obviously, the users can have enormous choices after comparing each service, but it remains significant problems.

Most of the users started to use the VoIP services because their friends or relatives also used the same VoIP services. Generally, most VoIP services only provided free charge in the same service provider; when users need to contact friends in other service provider, it costs additional fees. For example, users of the Skype service must use Skype software to receive and place VoIP calls. Besides, the Skype software can not be used for receiving and placing VoIP calls from different VoIP service provide, like Google Talk. So users need to install and setup more than one application on their personal computer in order to contact all their friends, it is extremely difficult for some elder or amateur users. As recited above, it is urgent to have some solutions for aforementioned problems.

### SUMMARY OF THE INVENTION

With respect to foregoing problems in the VoIP (voice over internet protocol) technologies, the present invention provides a system with virtual audio driver for the VoIP environment. The virtual audio driver is computer software, and it can be implemented by diverse possibilities. Including being implemented by different programming languages; supporting various operating systems (OS) and so on. It should be appreciated that the virtual audio driver is used for transferring the voice data, instead of producing the sounds. And all virtual audio drivers should be programmed under specified OS rules, all rules are provided by the manufacturers of the OS. So virtual audio driver can be installed in any operating system with no efforts, and also can be easily recognized by any OS. Besides, users can use the API (application programming interface) which is provided by the VoIP software development, like the Skype, to configure the voice input/output (I/O) of the demanded software, and redirect them to the virtual audio driver in the OS.

Besides, the present invention also provides a virtual telephone interface. The virtual telephone interface is third-party software, and can be compiled or reprogrammed in order to be suitable for any other operating system. And it also should be programmed under specified OS rules, all rules are provided by the manufacturers of the OS. The virtual telephone interface will process the incoming voice data which are received from the virtual audio driver, and the users can pick up the incoming calls by the virtual telephone interface. As well, the virtual telephone interface also can transfer the voice date of the users to the virtual audio driver, so the bi-directional communication can be established. With proper configuration, the user can use the virtual telephone interface to answer the incoming VoIP calls from multiple VoIP software in single application.

### BRIEF DESCRIPTION OF THE DRAWINGS

FIG. 1 is a block diagram, which is illustrated the relation between the virtual audio drivers and the accompanying applications in present invention.

FIG. 2 is a flow chart, which is illustrated that the method for transferring voice data from the VoIP client application to the virtual telephone interface through a virtual audio driver.

FIG. 3 is a flow chart, which is illustrated that the method for transferring voice data from the virtual telephone interface to the VoIP client application through a virtual audio driver.

### DETAILED DESCRIPTION OF THE PREFERRED EMBODIMENT

The present invention is described with preferred embodiments and accompanying drawings. It should be appreciated that all the embodiments are merely used for illustration. Although the present invention has been described in term of a preferred embodiment, the invention is not limited to this embodiment. It will be understood, however, to one skilled in the art, that the present invention may be practiced without some or all of these specific details. In other instances, well known process operations have not been described in detail in order not to unnecessary obscure the present invention.

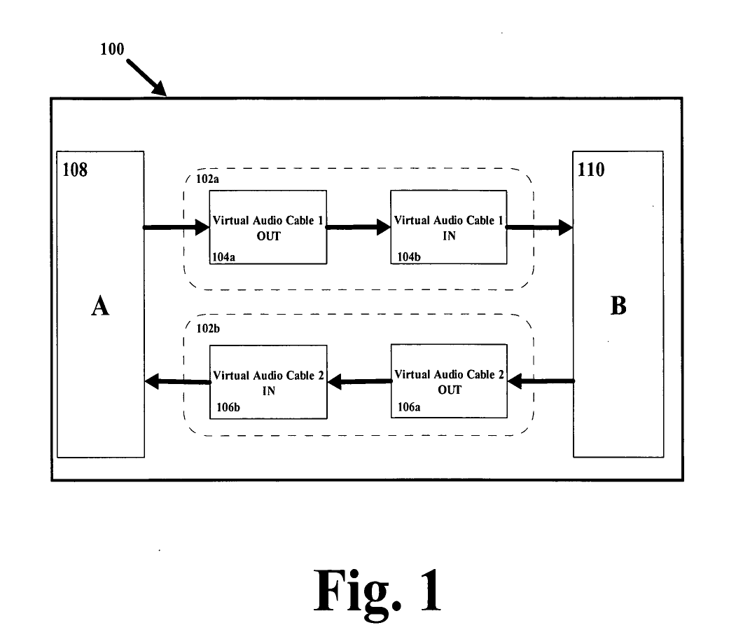

Referring to FIG. 1, which is a block diagram, illustrates the relation between virtual audio drivers and the accompanying application in the present invention. There is a system 100, and the system 100 comprises two virtual audio drivers 102a, 102b, a VoIP client application 108 and a virtual telephone interface 110. The virtual audio driver 102a includes a virtual audio cable 1 with out connector 104a and in connector 104b; in similar manner, the virtual audio driver 102b also includes a virtual audio cable 2 with out connector 106a and in connector 106b. The VoIP client application 108 can use its API (application programming interface) to setup outgoing voice data to the virtual audio driver 102a, and setup incoming voice data to the virtual audio driver 102b. With similar manner, the virtual telephone interface 110 select the virtual audio driver 102a as its input source, and select the virtual audio driver 102b as output port. After proper configuration, the voice data stream will route in the following manner as shown in the FIG. 1, the users can answer the incoming VoIP calls with the virtual telephone interface 110.

Besides, when there are multiple VoIP client applications in single system, users can answer incoming VoIP calls from different applications by single virtual telephone interface with proper configuration. Each VoIP client application is configured with two virtual audio drivers, and it should be appreciated that the configuration of each client application is shown as FIG. 1.

It should be appreciated that the virtual telephone interface did not need to support all VoIP protocols, because present invention gathers the voice data from upper layer instead of the network layer. Besides, users can install any kinds of the telephone applications not only the virtual telephone interface in present invention, only need to setup virtual audio drivers properly.

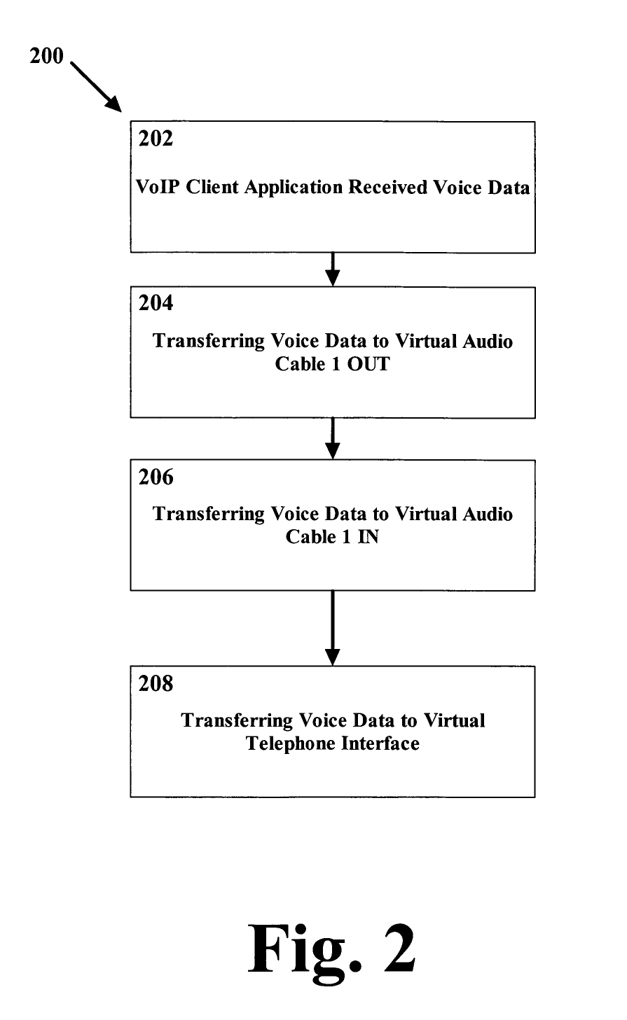

Referring to FIG. 2, which is a flow chart, illustrates a method 200 for transferring voice data from VoIP client application to the virtual telephone interface through a virtual audio driver. The method starts with the block 202, which presents VoIP client application received voice data. After the VoIP client application successfully process the incoming VoIP calls, at the block 204, passes the voice data to a virtual audio driver, and more specifically passes the voice data to an out connector of a virtual audio cable in the virtual audio driver. For the detailed description, please refer back to the FIG. 1. Then the voice data are passed to an in connector of a virtual audio cable in the virtual audio driver, and are prepared to transfer out, this all at block 206. Finally, the virtual audio driver sends the voice data to the destination, the virtual telephone interface at the block 208 for further processing.

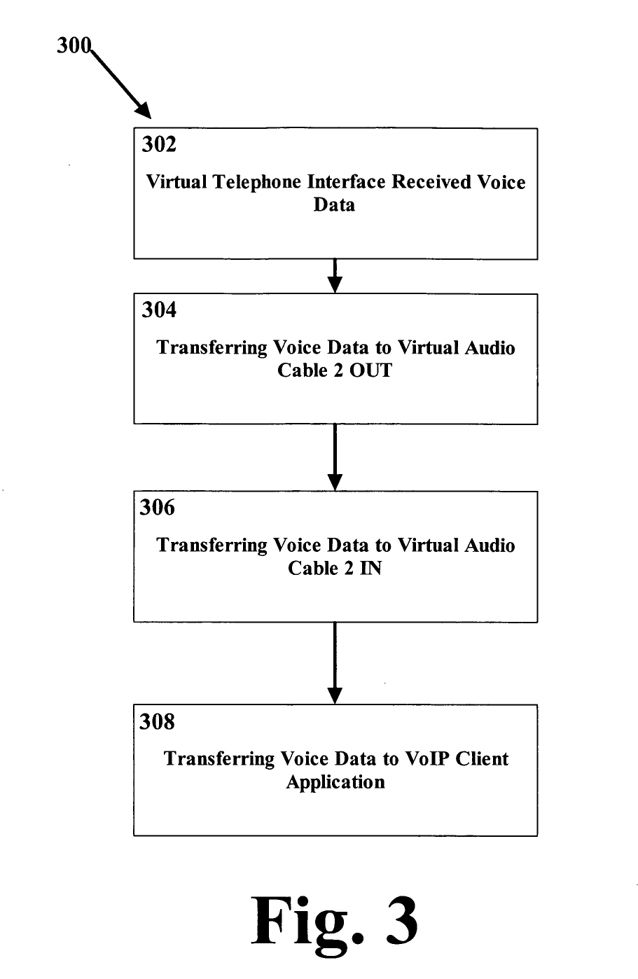

Referring to FIG. 3, which is a flow chart, illustrates a method 300 for transferring voice data from a virtual telephone interface to a VoIP client application through a virtual audio driver. The method starts with the block 302, which presents the virtual telephone interface received voice data. After the virtual telephone interface successfully process the incoming voice data, at the block 304, passes the voice data to a virtual audio driver, and more specifically passes the voice data to an out connector of a virtual audio cable in the virtual audio driver. For the detailed description, please refer back to the FIG. 1. Then the voice data are passed to an in connector of a virtual audio cable in the virtual audio driver, and are prepared to transfer out, this all at block 306. Finally, the virtual audio driver sends the voice data to the destination, the VoIP client application at the block 308 for further processing.

In combination of the aforementioned description, it can establish a looped communication flow between the VoIP client application and the virtual telephone interface. And with all this support, various uses can be implemented for future usage.

Other embodiments of the invention will be apparent to those skilled in the art from consideration of the specification and practice of the invention. The word “comprising” and forms of the word “comprising” as used in the description and in the claims are not meant to exclude variants or additions to the invention. Furthermore, certain terminology has been used for the purposes of descriptive clarity, and not to limit the present invention. The embodiments and preferred features described above should be considered exemplary, with the invention being defined by the appended claims.

We claim:

1. A system with virtual audio drivers for the VoIP (voice over internet protocol,) comprising:
a plurality of virtual audio drivers for receiving and transferring voice data;
a plurality of VoIP client applications which are coupled to said plurality of virtual audio drivers for receiving and transferring said voice data; and
a virtual telephone interface which is coupled to said virtual audio drivers for receiving and transferring said voice data.

2. The system of claim 1, wherein VoIP protocols of said VoIP client applications comprise H.323, SIP, and Skinny.

3. The system of claim 1, wherein said virtual audio driver further comprises a virtual audio cable.

4. The system of claim 3, wherein said virtual audio cable further comprises a virtual in connector and a virtual out connector.

5. The system of claim 4, wherein said voice data is transferred from said virtual out connector to said virtual in connector.

6. The system of claim 1, wherein said VoIP client application use corresponding API (application programming interface) to setup voice data flows.

7. The system of claim 1, wherein an output port and an input port of said virtual telephone interface are coupled to said virtual audio drivers.

8. The system of claim 1, wherein said virtual telephone interface is used for processing voice data, and outputting for a user.

9. A method for transferring voice data from a VoIP client application to a virtual telephone interface through a virtual audio driver, comprising:
receiving voice data by a VoIP client application;
transferring said voice data by said VoIP client application to an out connector of a virtual audio cable in said virtual audio driver;
transferring said voice data from said out connector to an in connector of said virtual audio cable in said virtual audio driver; and
transferring said voice data by said virtual audio driver to a virtual telephone interface.

10. The method of claim 9, wherein VoIP protocols of said VoIP client applications comprise H.323, SIP, and Skinny.

11. The method of claim 9, wherein said VoIP client application use corresponding API to setup voice data flows.

12. The method of claim 9, wherein an output port and an input port of said virtual telephone interface are coupled to said virtual audio drivers.

13. The method of claim 9, wherein said virtual telephone interface is used for processing voice data, and outputting for a user.

14. A method for transferring voice data from a virtual telephone interface to a VoIP client application through a virtual audio driver, comprising:
receiving voice data by a virtual telephone interface;
transferring said voice data by said virtual telephone interface to an out connector of a virtual audio cable in said virtual audio driver;
transferring said voice data from said out connector to an in connector of said virtual audio cable in said virtual audio driver; and
transferring said voice data by said virtual audio driver to a VoIP client application.

15. The method of claim 14, wherein VoIP protocols of said VoIP client applications comprise H.323, SIP, and Skinny.

16. The method of claim 14, wherein said VoIP client application use corresponding API to setup voice data flows.

17. The method of claim 14, wherein an output port and an input port of said virtual telephone interface are coupled to said virtual audio drivers.

18. The method of claim 14, wherein said virtual telephone interface is used for processing voice data, and outputting for a user.
